(19) United States
(12) Patent Application Publication
(10) Pub. No.: US 2008/0091284 A1
(43) Pub. Date: Apr. 17, 2008

(54) Device Operation Control Device and Method Thereof

(76) Inventors: Keiji Sugiyama, Kyoto (JP); Kakuya Yamamoto, Hyogo (JP)

Correspondence Address: WENDEROTH, LIND & PONACK L.L.P., 2033 K. STREET, NW, SUITE 800, WASHINGTON, DC, 20006, US

(21) Appl. No.: 11/793,141

(22) PCT Filed: Dec. 26, 2005
(86) PCT No.: PCT/JP05/23779

§ 371 Date: Jun. 18, 2007

(30) Foreign Application Priority Data
Jan. 13, 2005 (JP) 2005-005991

(51) Int. Cl. G06F 17/00

(52) U.S. Cl. 700/90

(57) ABSTRACT

Appropriate operation control over appliances is provided depending on the status of the user and the appliances. An appliance status acquisition unit 101 acquires the operating status of appliances used by a user and a user status acquisition unit 102 acquires user information related to the user. An appliance status management unit 103 makes an assessment as to the need for operation control over the appliances based on the operating status and user status. An activity concern level assessment unit 104 makes an assessment as to the user's level of concern with the activities of the appliances based on the operating status and user status and an activity importance level assessment unit 105 makes an assessment as to the importance level of the activities of the appliances based on the operating status and user status. An appliance operation arbitration unit 107 determines the method of operation control over the appliances based on the level of concern and the level of importance and an appliance operation control unit 107 provides operation instructions to the appliances. Such an appliance operation control device 100 makes it possible to carry out operation control of a plurality of appliances not only with account taken of the status of the appliances, but also based on the status of the user, with account taken of the importance level of the activities of the appliances and the user's level of concern and personal preferences with respect to the activities of the appliances.

### TECHNICAL FIELD

The present invention is concerned with an appliance operation control device and method for controlling the operation of a plurality of appliances.

### BACKGROUND ART

Appliance operation control systems used for controlling the operation of a plurality of appliances have been known in the past. Appliance operation control systems are systems that monitor electric power consumed by household appliances as well as noise etc. generated by the appliances and control the operation of the appliances such that the total electric power consumption and the amount of the noise of a household do not exceed certain thresholds. Such an appliance operation control system is disclosed in Japanese Laid-Open Patent No. 2002-369383 A, according to which the appliance operation control system of Japanese Laid-Open Patent No. 2002-369383 A is capable of preventing situations, in which home appliances overusing electric power, and achieves the effect of eliminating noise-induced user discomfort.

### DISCLOSURE OF THE INVENTION

However, when a plurality of appliances are being controlled, it is not sufficient to use only the information coming from the appliances, such as power consumption, generated noise, acceptability of interruptions during processing, etc. For instance, when a user is watching TV while preparing a meal in an IH (induction heating) cooker, powering off the TV based on a decision relying only on power consumption may cause displeasure to a user who is more concerned with watching TV than cooking.

The present invention addresses the conventional problems described above and it is an object of the invention to provide an appliance operation control device capable of carrying out operation control over appliances used by the user in a manner appropriate to the user, as well as a control method therefor.

In order to address the problem described above, the present invention 1 provides an appliance operation control device comprising an appliance status acquisition unit, a user status acquisition unit, a appliance status acquisition unit, an activity importance level assessment unit, an appliance operation arbitration unit, and an appliance operation control unit. The appliance status acquisition unit acquires the respective operating status of each appliance used by the user. The user status acquisition unit acquires a user status associated with the user. The activity concern level assessment unit assesses the user's level of concern with the activities performed by the appliances based on the user status or the user status and the operating status of the appliances. The activity importance level assessment unit assesses the level of importance of the activities of the appliances based on the operating status of the appliances or the operating status of the appliances and the user status. The appliance status management unit makes an assessment as to whether or not there is a need for operation control over the appliances used by the user based on the operating status of the appliances and the user status. The appliance operation arbitration unit determines the method of operation control over the appliances based on the level of concern and the level of importance when the appliance status management unit makes an assessment that there is a need for operation control. The appliance operation control unit carries out the operation control over the appliances based on the operation control method determined by the appliance operation arbitration unit.

As a result, operation control over a plurality of appliances can be carried out not only with account taken of the status of the appliances, but also based on the status of the user, with account taken of the user's level of concern with the activities of the appliances and the level of importance of the activities of the appliances. For this reason, for instance, when a user who is watching TV while preparing a meal in an IH cooker is more concerned with watching TV than cooking, the invention makes it possible to avoid situations, in which displeasure to the user would be caused by powering off the TV, which of greater concern to the user. Moreover, when an activity taking place in the IH cooker is an activity involving a cooking step of high importance level, processing such as powering off the TV is performed in order to give priority to processing of high importance level even though the user may be strongly concerned with watching TV.

The present invention 2 provides an appliance operation control device characterized by the fact that, in the invention 1 described above, the user status acquired by the user status acquisition unit contains information on the amount of current user-providable resources, and the appliance status management unit assesses the amount of the resources required by the appliances to carry out the activities depending on the operating status of the appliances acquired by the appliance status acquisition unit, and makes an assessment as to whether or not there is a need for operation control by comparing the total value of the resources required by the appliances and the amount of current user-providable resources.

This permits proper operation control over a plurality of appliances even in case of fluctuations in the electric power, communication bands, financial assets, and other user-providable resources.

The present invention 3 provides an appliance operation control device characterized by the fact that, in the invention 1 described above, the activity concern level assessment unit assesses the user's level of concern with the activities of the appliances based on at least one parameter among the distance between the user and the appliances, the frequency of viewing with which the user views the appliances, the manipulation frequency with which the user manipulates the appliances, and the user's personal preferences with respect to the activities of the appliances that are acquired by the user status acquisition unit.

As a result, the user status makes it possible to infer which appliance the user is currently concerned with and appliance operation control is carried out with account taken of the user's level of concern.

The present invention 4 provides an appliance operation control device characterized by the fact that, in the invention 2 described above, the operation control carried out by the appliance operation arbitration unit includes allocation of current user-providable resources acquired by the user status acquisition unit to the appliances based on the values of importance level and concern level.

As a result, activities can be carried out without being interrupted because relatively more resources can be allocated to appliances of higher concern to the user and to appliances performing important activities.

The present invention 5 provides an appliance operation control device characterized by the fact that, in the invention 2, the resources are the level of the user's contribution to the activities of the appliances.

As a result, the user's concentration and attention can be treated as resources, which makes it possible to avoid situations, in which the user becomes confused when a plurality of appliances simultaneously request operations to be performed by the user.

The present invention 6 provides an appliance operation control device characterized by the fact that, in the invention 4, the resources are the level of the user's contribution to the activities of the appliances.

Moreover, in order to address the problem described above, the present invention 7 offers an appliance operation control method executable by a computer. The appliance operation control method comprises an appliance status acquisition step, a user status acquisition step, an activity concern level assessment step, an activity importance level assessment step, an appliance status management step, an appliance operation arbitration step, and an appliance operation control step. The appliance status acquisition step involves acquiring the respective operating status of the appliances used by the user. The user status acquisition step involves acquiring the user status. The activity concern level assessment step involves assessing the user's level of concern with the activities performed by the appliances based on the user status or the user status and the operating status of the appliances. The activity importance level assessment step involves assessing the importance level of the activities of the appliances based on the operating status of the appliances or the operating status of the appliances and the user status. The appliance status management step involves making an assessment as to whether or not there is a need for operation control over the appliances used by the user based on the operating status of the appliances and the user status. The appliance operation arbitration step involves determining the method of operation control over the appliances based on the level of concern and the level of importance when the appliance status management unit makes an assessment that there is a need for operation control. The appliance operation control step involves carrying out the operation control over the appliances based on the operation control method determined in the appliance operation arbitration step.

As a result, operation control over a plurality of appliances can be carried out not only with account taken of the status of the appliances, but also based on the status of the user, with account taken of the user's level of concern with the activities of the appliances and the level of importance of the activities of the appliances. For this reason, for instance, when a user who is watching TV while preparing a meal in an IH cooker is more concerned with watching TV than cooking, the invention makes it possible to avoid situations, in which displeasure to the user would be caused by powering off the TV, which is of greater concern to the user. Moreover, when the activity taking place in the IH cooker is an activity involving a cooking step of high importance level, processing such as powering off the TV is performed in order to give priority to processing of high importance level even though the user may be strongly concerned with watching TV.

The present invention 8 provides an appliance operation control program, which directs a computer to function as appliance status acquisition unit for acquiring the respective operating status of appliances used by a user; user status acquisition unit for acquiring a user status associated with the user; activity concern level assessment unit for assessing the user's level of concern with the activities carried out by the appliances based on the user status or the user status and the operating status of the appliances; activity importance level assessment unit for assessing the importance level of the activities of the appliances based on the operating status of the appliances or the operating status of the appliances and the user status; appliance status management unit for making an assessment as to whether or not there is a need for operation control over the appliances used by the user based on the operating status of the appliances and the user status; appliance operation arbitration unit for determining the method of operation control over the appliances based on the level of concern and the level of importance when the appliance status management unit makes an assessment that there is a need for operation control; and appliance operation control unit for carrying out the operation control over the appliances based on the operation control method determined by the appliance operation arbitration unit.

The present invention 9 provides a computer-readable recording medium having recorded thereon an appliance operation control program executable by a computer, wherein the computer-readable recording medium has recorded thereon an appliance operation control program executing the steps of: appliance status acquisition involving acquiring the respective operating status of appliances used by a user; user status acquisition involving acquiring a user status associated with the user; activity concern level assessment involving assessing the user's level of concern with the activities carried out by the appliances based on the user status or the user status and the operating status of the appliances; activity importance level assessment involving assessing the importance level of the activities of the appliances based on the operating status of the appliances or the operating status of the appliances and the user status; appliance status management involving making an assessment as to whether or not there is a need for operation control over the appliances used by the user based on the operating status of the appliances and the user status; appliance operation arbitration involving determining the method of operation control over the appliances based on the level of concern and the level of importance when an assessment is made in the appliance status management step that there is a need for operation control; and appliance operation control involving carrying out the operation control over the appliances based on the operation control method determined in the appliance operation arbitration step.

In addition, the scope of the present invention also includes a computer-readable recording medium, which has recorded thereon a computer program directing a computer to execute the method described above, as well as a program therefor. Here, flexible disks, hard disks, CD-ROMs, MOs, DVDs, DVD-ROMs, DVD-RAMs, BDs (Blue-ray Disks), and semiconductor memory can be cited as examples of the computer readable recording media. The computer program mentioned above is not limited only to programs recorded on the recording media described above and may be transmitted through networks etc. represented by telecommunication lines, wireless or wired communication lines, and the Internet.

The appliance operation control device of the present invention makes it possible to exercise operation control over a plurality of appliances not only with account taken of the status of the appliances, but also based on the status of the user, with account taken of the user's level of concern with the activities of the appliances and the level of importance of the activities of the appliances.

### BRIEF DESCRIPTION OF DRAWINGS

FIG. 1 is an overall block diagram of the appliance operation control system used in an embodiment of the present invention.

FIG. 2 is an operation flow of the appliance operation control system used in an embodiment of the present invention.

FIG. 3 is an operational content table for appliances used in an embodiment of the present invention.

FIG. 4 illustrates metadata showing the operational content of appliances used in an embodiment of the present invention.

FIG. 5 is an ontology used for interpreting the metadata of appliances used in an embodiment of the present invention.

FIG. 6 is an exemplary user status in an embodiment of the present invention.

FIG. 7 illustrates user preference information in an embodiment of the present invention.

FIG. 8 illustrates user-providable resources in an embodiment of the present invention.

FIG. 9 is an operation rank table used for appliances in embodiment 1 of the present invention.

FIG. 10 is a concern level computation table used in an embodiment of the present invention.

FIG. 11 illustrates concern level computation in an embodiment of the present invention.

FIG. 12 is an importance level assessment table used in an embodiment of the present invention.

FIG. 13 is a processing flow chart of resource allocation in an embodiment of the present invention.

### BEST MODE FOR CARRYING OUT THE INVENTION

Embodiments of the present invention are explained below by referring to drawings.

<Configuration>

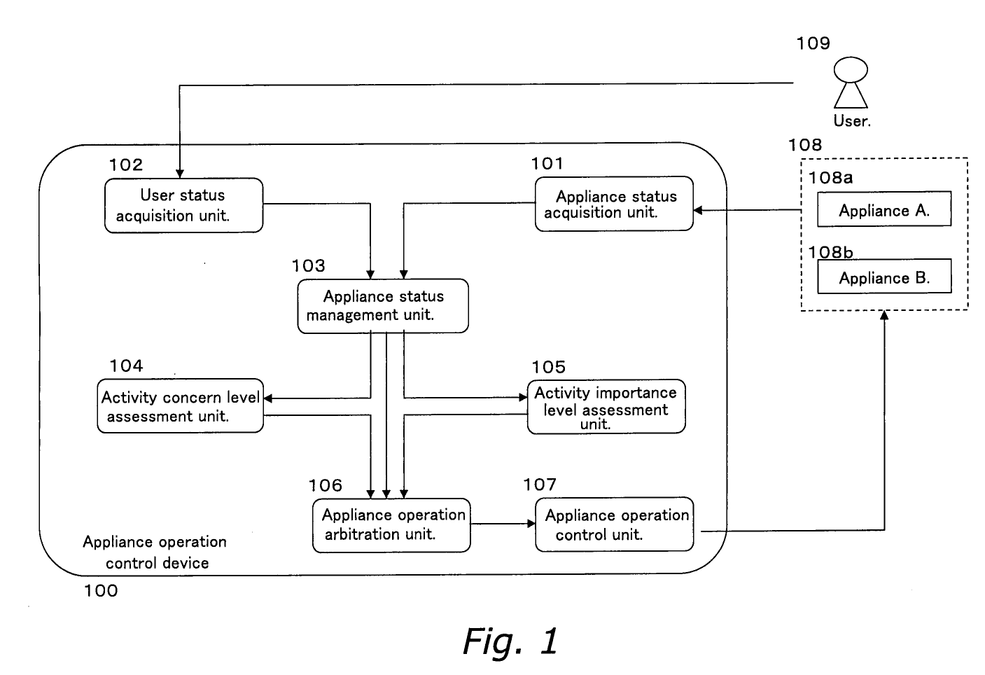

A block diagram of the appliance operation control device used in an embodiment of the present invention is illustrated in FIG. 1. An appliance operation control device 100, which is illustrated in FIG. 1, is made up of an appliance status acquisition unit 101, a user status acquisition unit 102, an appliance status management unit 103, an activity concern level assessment unit 104, an activity importance level assessment unit 105, an appliance operation arbitration unit 106, and an appliance operation control unit 107. Additionally, an appliance group 108, which is used by a user 109, contains individual appliances 108a and 108b.

Here, the appliance operation control device 100 of FIG. 1 may be formed on a wearable device, e.g. an HMD (Head Mounted Display) or a user terminal belonging to the user, such as in a mobile phone or a personal computer, or may be installed on a server on a network. Moreover, the appliance operation control device 100 may be formed on a single terminal or server, or may be formed using a plurality of terminals and servers.

The constituent parts of the appliance operation control device 100 are explained in detail below.

(Appliance Status Acquisition Unit 101)

The appliance status acquisition unit 101 acquires the operating status of the appliances used by the user.

Explanations regarding the method used for appliance status acquisition by the appliance status acquisition unit 101 are provided next. Under the appliance operating status acquisition method, current information on the appliances is transmitted by the appliances in a proprietary data format and the appliance status acquisition unit 101 receives and analyzes the information transmitted by the appliances. Moreover, a method, wherein the appliance status acquisition unit 101 makes a decision regarding the current operating status of the appliances by conducting information interchange with the appliances using a standard protocol used for information interchange with appliances, such as UPnP (Universal Plug and Play) and SOAP (Simple Object Access Protocol), may be used as the method of acquisition of the operating status of the appliances. There are no particular limitations concerning the timing with which the operating status of the appliances is acquired, and it is possible to use a method, in which the appliance status acquisition unit 101 polls the appliances used by the user 109 at regular intervals. Moreover, when the appliances used by the user 108 change the way they operate, a method may be used, in which the appliances used by the user 109 transmit current operation-related information to the appliance status acquisition unit 101 in accordance with the altered timing of operation. Furthermore, methods based on recording media may be used, as well as methods, in which information on the appliances used by the user is acquired when the user 109 directly inputs it into a device including the appliance operation control device 100.

It should be noted that the operating status of the appliances acquired by the appliance status acquisition unit 101 preferably includes the power consumption required by the appliances, the network bands, and other requested resources required by the appliances, as well as the generated noise, etc. Moreover, the titles of the performed activities and other higher-order information may be included in the operating status of the appliances acquired by the appliance status acquisition unit 101.

(User Status Acquisition Unit 102)

The user status acquisition unit 102 acquires the current user status. Here, the term “user status” refers to the distance between the user 109 and the appliances A and B, i.e. 108a, 108b, which constitute the group of appliances 108 used by the user, the frequency of manipulation of the appliances 108a, 108b by the user 109, the frequency of viewing of the appliances 108a, 108b by the user 109, or information on the personal preferences the user 109 has with respect to the activities of the appliances 108a, 108b, etc. Moreover, information on resources that can be provided by the user 109 at the present moment can be acquired as the user status.

The method for acquiring user status may consist in acquiring the distance between the user 109 and the appliances 108a, 109b, the frequency of manipulation of the appliances 108a, 109b by the user 109, and the frequency of viewing at which the user 109 views the appliances 108a, 109b, using, for example, a camera that is provided in the user's home. In addition, a method that measures the distance etc. between the user 109 and the appliances 108a, 108b by providing RFID (Radio Frequency IDentification) tags and RFID tag readers may also be used for acquiring the user status. Furthermore, a method, in accordance with which the user 109 wears a transparent HMD (Head Mounted Display) or another wearable device and the line of sight and biometric information on the user 108 are detected using sensors and a camera housed in the wearable device in order to acquire the frequency of viewing of the appliances 108a, 108b by the user 109, the current level of his or her concentration, etc., may also be used as a method of user status acquisition. Moreover, a method, in which information on the resources that can be provided by the user 109 is acquired from a presence server (not shown) etc. on a network, may be used as a method of user status acquisition.

(Appliance Status Management Unit 103)

The appliance status management unit 103 makes an assessment as to whether or not there is a need to exercise control such as providing instructions regarding changes in the operational content for the appliances 108a, 108b used by the user 109 based on the operating status of the appliances acquired by the appliance status acquisition unit 101 and the user status of the user 109 acquired by the user status acquisition unit 102.

The assessment of whether or not there is a need for carrying out such control depends on the amount of resources that can be provided by the user 109 and the amount of resources requested by the appliances 108a, 108b. When the total of the resources requested by the appliances 108a, 108b exceeds the amount of resources that can be provided by the user 109 (amount of resources that can be provided by the user 109<amount of resources requested by the appliances), the appliance status management unit 103 makes an assessment that there is a need to exercise control over operational content for appliances 108a, 108b.

Here, the word “resources” is a generic name for operation ranks, electric power, communication bands, financial assets, and other things required by appliances 108a, 108b for operation. The operation ranks are indicators representing the strength of the involvement of the user 109 in an activity and calculated based on the level of contribution by the user 109 to the activity, such as the number of times the user 109 has to manipulate the appliances 108a, 108b when performing the activity, the level of concentration of the user 109 that is expected to be necessary in the course of execution of the activity, etc. Using the operation rank, the appliance status management unit 103 makes an assessment as to whether or not the level of contribution by the user 109 requested by the appliances 108a, 108b exceeds the level of contribution that the user can offer (concentration, number of manipulations that can be carried out at a time, etc.). In addition, if necessary, the appliance status management unit 103 can perform application operation control such as stopping the operation of other appliances to allow the user 109 to concentrate on operating a single appliance.

In this manner, using the “operation rank” parameter, which represents the level of contribution by the user 109 to an activity required number of manipulations or concentration, makes it possible to prevent situations, in which a plurality of appliances 108a, 108b have to be operated by the user 109 simultaneously, thereby causing the user 109 to become distracted and, as a result, causing errors in operation.

It should be noted that the resources are not limited to the resources exemplified above and the danger involved in the operation of the appliances 108a, 108b, the operational efficiency, generated noise, etc. can be represented as numerical values and handled as resources as well. When danger is handled as a resource, the appliance status management unit 103 determines whether or not there is a need for operation control over the appliances based on the level of danger permissible for the user 109 and the total amount of danger involved in the activities of the appliances 108a, 108b.

It should be noted that information relating to the resources required by the appliances 108a, 108b may be acquired as the current appliance operating status by the appliance status acquisition unit 101 from the group of appliances 108 used by the user. In addition, the appliance status management unit 103 may acquire the amount of resources currently required by the appliances 108a, 108b by storing information on the resources required for each operating status of the appliances 108a, 108b in a database in conjunction with the names of the activities and matching the resources required by each operating status of the appliances 108a, 108b and the names of the activities performed by the appliances 108a, 108b. Here, the database storing the information on the resources required for each operating status of the appliances 108a and 108b is maintained by the appliance status management unit 103. Moreover, the names of the activities performed by the appliances 108a and 108b are acquired by the appliance status acquisition unit 101 from the appliance group 108 used by the user.

(Activity Concern Level Assessment Unit 104)

The activity concern level assessment unit 104 assesses the level of concern the user 109 has with respect to the appliances of the group of appliances 108 currently used by the user 109.

Although not limited to particular means, the method used by the activity concern level assessment unit 104 to assess the level of concern involves performing such assessment based on the user status acquired by the user status acquisition unit 102 based on guidelines, in accordance with which, for instance, there is a more immediate concern with appliances 108a, 108b located at a closer distance from the user 109 and stronger concern with appliances characterized by high frequencies of manipulation and viewing by the user 109, etc. In addition, to determine the level of concern, a method may be used, wherein the current level of concern with the appliances 108a, 108b on the part of the user 109 is assessed by matching the operational content carried out by the appliances 108a, 108b or the appliances 108a, 108b with information regarding the user's personal preferences. For instance, when “cooking” is described as the personal preference of the user 109, the activity concern level assessment unit 104 makes assessment according to guidelines such as increasing the level of concern with the IH cooker or increasing the level of concern with TV when the TV is playing back a TV cooking show.

In this manner, the activity concern level assessment unit 104 determines the level of concern on the part of the user 109 based on at least one parameter among the distance between the user 109 and the appliances 108a, 108b, the frequency of viewing with which the user 109 views the appliances 108a, 108b, the frequency of manipulation with which the user 109 manipulates the appliances, and the personal preferences of the user 109 with respect to the activities of the appliances 108a, 108b. As a result, using the constantly changing relationship between the user 109 and the appliances 108a, 108b makes it possible to calculate the concern for appliances 108a, 108b on the part of the user 109.

(Activity Importance Level Assessment Unit 105)

The activity importance level assessment unit 105 assesses the importance level attached to the appliances 108a, 108b of the appliance group 108 currently used by the user 109.

The “importance level” assessed by the activity importance level assessment unit 105 is an indicator determined by dangers involved in activities, advantages obtained from the activities, etc., with the risk resulting from a failure of an activity being proportionately higher for activities of high importance level. There are no particular limitations concerning the method used for assessing the importance level attached to the appliances 108a, 108b, which may consist in the appliances 108a, 108b directly transmitting their own importance level to the appliance status acquisition unit 101, or in storing the level of importance attached by the activity importance level assessment unit 105 to the appliances 108a, 108b or to their operational content in the form of a database and then determining the corresponding level of importance based on this database and the names of the activity content acquired by the appliance status acquisition unit 101.

(Appliance Operation Arbitration Unit 106)

When the appliance status management unit 103 makes an assessment that there is a need to exercise control over the appliances 108a, 108b used by the user 109, the appliance operation arbitration unit 106 determines the resources allocated to the appliances. The appliance operation arbitration unit 106 determines the resources allocated to the appliances 108a, 108b using the level of the user's concern with the appliances assessed by the activity concern level assessment unit 104 and the level of importance attached to the appliances 108a, 108b assessed by the activity importance level assessment unit 105. The operation of the appliances is determined by the allocation of resources.

The method of resource allocation does not need to be limited to a particular algorithm, but the resources are preferentially allocated to appliances 108a, 108b with an importance level that is not less than a certain value. It is possible to use an algorithm, wherein the allocation of resources to an appliance group 108 whose importance level is below a certain value is performed by preferentially allocating the resources starting from appliances 108a, 108b having a high level of concern. In addition, the method of resource allocation may consist in assigning operation ranks to the appliances 108a, 108b as resources in order to control the user's level of contribution to, and concentration on, the activities. In case of appliances 108a, 108b with high assigned operation ranks, the appliances 108a, 108b are enabled for activities with a higher level of user contribution. For instance, it becomes possible to carry out activities requiring high concentration on the part of the user 109, such as during the finishing stages of meal preparation, etc., activities the user 109 is concerned with, such as playback of the user's favorite TV shows, or complex activities requiring multiple operations and decisions of the user 109, such as settling accounts during electronic commercial transactions and the like. Conversely, appliances 108a, 108b with lower assigned operation ranks carry out activities that do not require contribution on the part of the user 109, such as recording shows etc.

In this manner, the appliance operation arbitration unit 106 determines the method of operation control by allocating resources that can be provided to the appliances at the present moment, as acquired by the user status acquisition unit 102, to the appliances 108a, 108b based on the values of the level of concern and the level of importance attached to the appliances 108a, 108b. As a result, appliances with which the user is strongly concerned and appliances performing activities of high importance level that cannot fail get proportionately more resources and can continue operation without interruption or changes in their activities.

(Appliance Operation Control Unit 107)

The appliance operation control unit 107 makes use of a user terminal display etc. to notify the user of the operation control method etc. determined based on the resources allocated by the appliance operation arbitration unit 106 to the appliances 108a, 108b. If the user has authorized appliance operation control, the operation control over the appliances 108a, 108b is carried out in accordance with the determined operation control method. If the user has not authorized appliance operation control, processing is terminated without execution.

Now explanations will be provided regarding the specifics of the control method implemented by the appliance operation control unit 107. The appliance operation control unit 107 maintains a list of the operational content executable by the appliances 108a, 108b. Thus, from the list, the appliance operation control unit 107 selects operational content executable by the appliances 108a, 108b using the allocated resources. Next, the appliance operation control unit 107 notifies the user of the selected operational content through the display of a user terminal, etc. When an authorization to operate is inputted by the user, the appliance group 108 is directed to execute the operations. Otherwise, the appliance operation control unit 107 may transmit only information on the resources allocated to the appliances 108a, 108b, and the appliances 108a, 108b, in turn, may make an assessment and determine the processing that can be carried out using the resources they have been notified about. At such time, the appliance group 108 is used by the user 109.

An appliance operation control device of the configuration described above makes it possible to carry out operation control over a plurality of appliances 108a, 108b by taking into account not only the status of the appliances, but also the level of concern with the appliance activities on the part of the user 109, the influence of the activities of the appliances 108a, 108b on the safety of the user 109, etc.

<Operating Procedure>

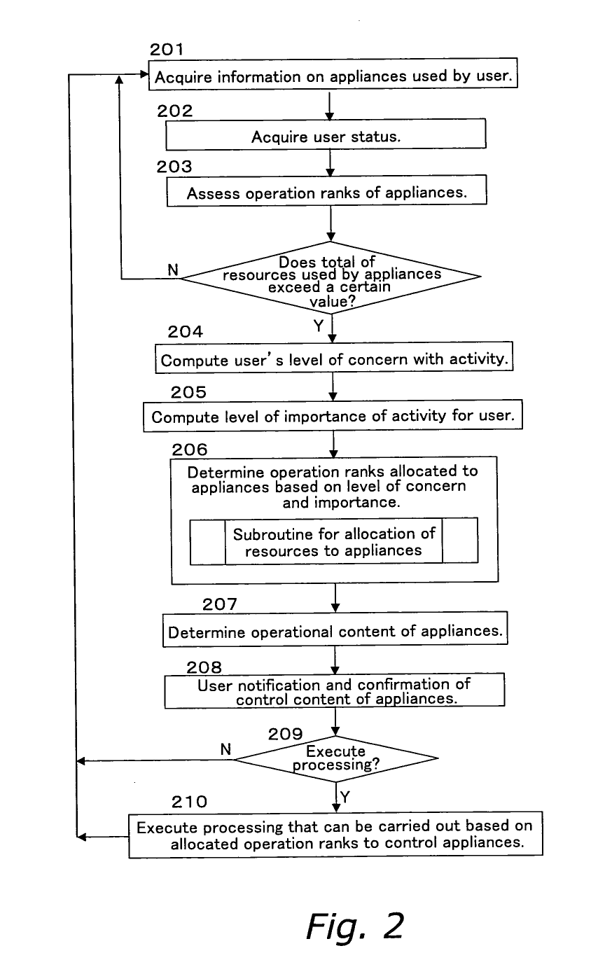

Next, explanations will be provided regarding the operating procedure used by the appliance operation control device of the present invention to control appliances used by the user. FIG. 2 is an operation flow chart used for the inventive appliance operation control device in a first embodiment. An example of appliance operation control, including steps 201˜210, is explained below.

(Step 201)

The appliance status acquisition unit 101 acquires information on the status of the appliances belonging to the appliance group 108 currently used by the user 109. The method used by the appliance status acquisition unit 101 to request the operating status of the appliances being used by the user 109 is described below.

1. Use of the User Appliance List

The names of appliances that can be used by the user 109 and information necessary for connecting to the appliances (IP address or authorization information) is maintained by the appliance status acquisition unit 101 in the form of an appliance information list. When acquiring the operating status of the appliances, the appliance status acquisition unit 101 uses the information in the appliance information list to request operation status for said appliances.

2. Use of Broadcasting

The appliance status acquisition unit 101 broadcasts a message requiring appliances on the network to notify it of their current operating status. The appliances that receive the message from the appliance status acquisition unit 101 analyze the content of the message to determine whether or not to send the operating status to the appliance status acquisition unit 101 and send their current operating status if necessary.

3. Use of the Information Management Server

The appliance status acquisition unit 101 identifies the appliances currently used by the user 109 and acquires their operating status by inquiring a network server of the current operating status of the appliances. This is done because the network server manages the operating status of the appliances of the user 109.

It should be noted that the unit used by the appliance status acquisition unit 101 to request information on the appliances being used by the user 109 may be a combination of the items 1-3 described above. Otherwise, another unit that can be used consists in issuing an inquiry via a P2P (Peer-to-Peer) network.

In addition, the information acquired by the appliance status acquisition unit 101 from the appliances being used by the user is expected to be of the following two kinds.

1. Names of Operational Content

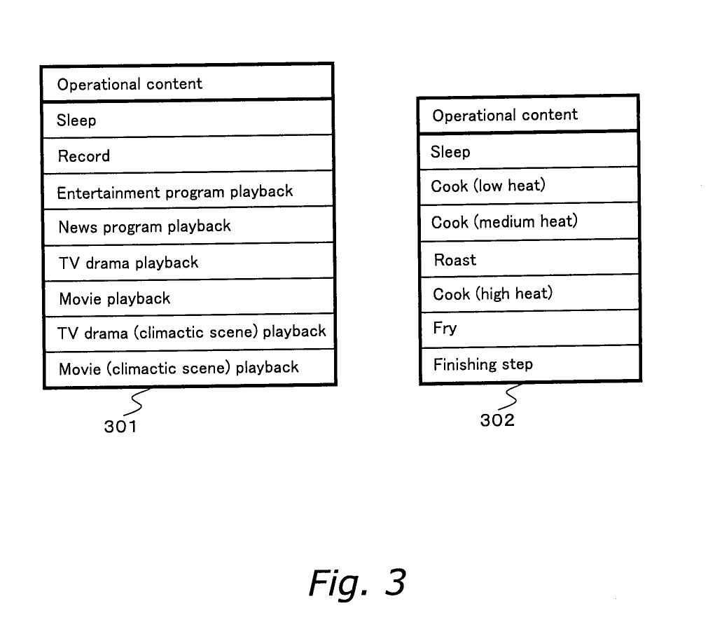

FIG. 3 shows operational content tables. In FIG. 3, the key 301 designates an exemplary TV operational content table, and the key 302 an exemplary IH cooker operational content table. As illustrated in FIG. 3, the appliance status acquisition unit 101 maintains information on the operations that can be carried out by the appliances in the form of an operational content table, and, from the appliances, it acquires only names corresponding to the operational content listed in the table. For example, a TV, which is currently playing back a news program, transmits the name of an operational content item called “news program playback” to the appliance status acquisition unit 101 of the appliance operation control device 100 and the appliance status acquisition unit 101 acquires the name of the operational content item sent by the TV. Also, an IH cooker, which is currently performing the task of cooking at low heat, sends the name of an operational content item called “cook (low heat)” to the appliance status acquisition unit 101 of the appliance operation control device 100 and the appliance status acquisition unit 101 acquires the name of the operational content item transmitted by the IH cooker.

2. Metadata of Operational Content

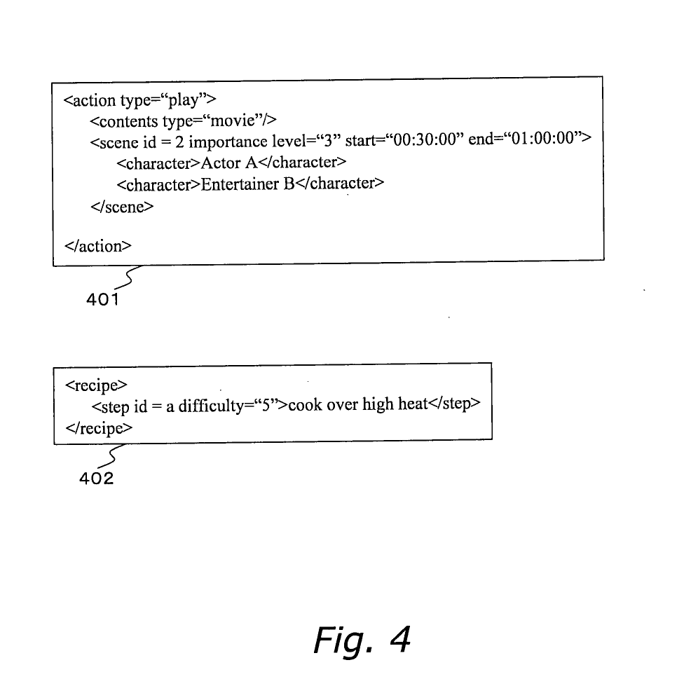

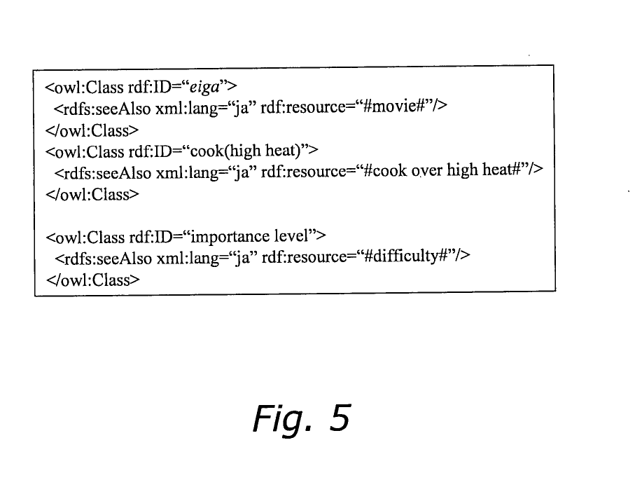

FIG. 4 shows the ontology used for interpreting metadata associated with the appliances. The appliance status acquisition unit 101 assesses the current operational content of the appliances by acquiring metadata showing the operational content of the appliances, as shown in FIG. 4. In FIG. 4, the key 401 indicates metadata illustrating the operational content item currently performed by the TV, with the metadata recorded in XML format. It shows an operational content item “specific movie scene playback” currently performed by the TV. In addition, the key 402 in FIG. 4 indicates metadata illustrating operations currently performed by the IH cooker, with the metadata recorded in XML format. It shows that currently the IH cooker is “currently performing the activity of cooking at high heat”. The appliance status acquisition unit 101 interprets the content of the acquired metadata with the help of an ontology illustrated in FIG. 5. An “ontology” shows semantic relationships between terms. For instance, an ontology can be used to determine that the Japanese word “eiga” and the word “movie” have the same meaning. The appliance status acquisition unit 101 controls appliance operational content by using ontology to determine which activities in the operational content table of FIG. 3 corresponds to the activities represented by the acquired metadata.

The appliance status acquisition unit 101 notifies the appliance status management unit 103 of the operational content of the appliances used by the user 109.

(Step 202)

The user status acquisition unit 102 acquires the current status of the user 109. The operating status associated with the appliances 108a, 108b being used by the user 109, as well as the status associated with the amount of resources that the user 109 can provide, are suggested as the user 109 status to be acquired.

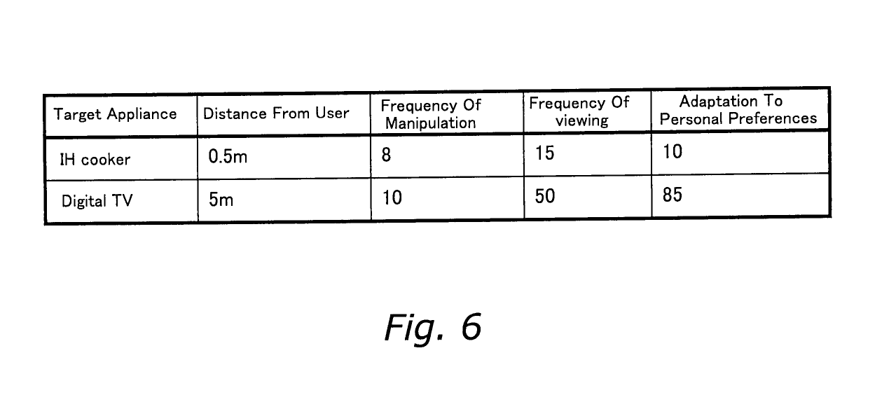

The status of the user 109 associated with the appliances 108a, 108b being used by the user 109 is illustrated in FIG. 6. FIG. 6 is formed in accordance with the current relationship between the user 109 and the appliances in terms of the distance between the user 109 and the appliances, the frequency of manipulation, the frequency of viewing, and personal interests and preferences. In particular, while the distance between the user 109 and the appliances, the frequency of manipulation, and the frequency of viewing represent current physical information on the user 109 and the appliances, adaptation to personal preferences is concerned with information that links the user's likes and dislikes with the activities because the user 109 directs the activity of each appliance based on personal preferences and interests. The user status acquisition unit 102 updates the table at the appropriate timings. Methods used for acquiring the data stored in FIG. 6 include a method, in which the user status acquisition unit 102 acquires information using cameras or sensors installed on the premises of the user 109 or the camera and sensor functionality of a terminal that the user carries along.

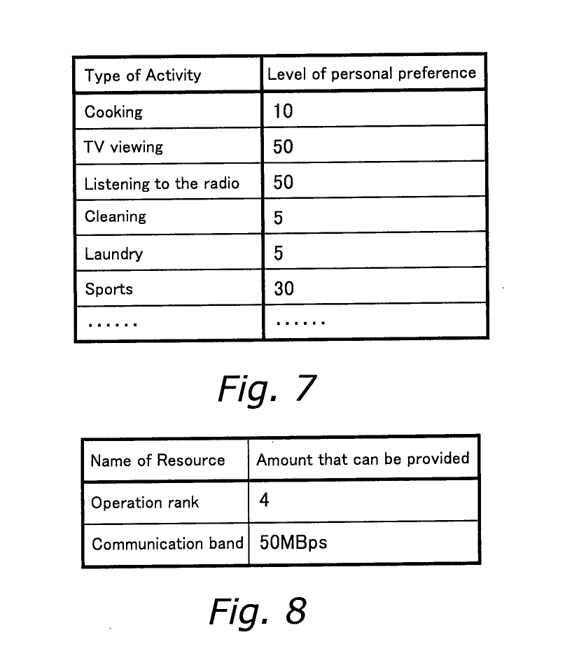

In addition, as shown in FIG. 7, the user status acquisition unit 102 maintains a user profile, which stores information associated with the personal preferences and interests of the user 109, and the level of adaptation of the appliances to the personal preferences of the user 109, which is mentioned in FIG. 6, is calculated using this table.

Moreover, the user status acquisition unit 102 maintains information on the amount of providable resources that the user 109 can provide. FIG. 8 illustrates a table of information concerning the amount of providable resources that the user 109 can provide. Here, the operation rank is an indicator which, as described above, is used for the actual allocation of various levels of user contribution to the appliances. The higher the providable amount corresponding to the operation rank shown in FIG. 8, the more the user 109 can concentrate on the activities of the appliances. The user status acquisition unit 102 computes the operation rank that can be allocated by the user 109 e.g. by inferring the status of the user using a biosensor in a terminal carried along by the user 109, or by distinguishing how busy the user currently is based on the schedule of the user 109. In addition, the user status acquisition unit 103 acquires information on the communication bands that can be allocated by inquiring a router etc. on the premises of the user.

The user status acquisition unit 102 notifies the appliance status management unit 103 of the acquired user status.

It should be noted that the operation rank may also be determined based on the time zone and the user profile, including the sex and age of the user. For instance, if the user is a child, the operation rank is lowered and the user-providable resources are reduced. In addition, if it is late night in this time zone, generally speaking, the amount of resources that the user can provide tends to be smaller and the operation rank is reduced.

(Step 203)

The appliance status management unit 103 uses the operating status of the appliances provided by the appliance status acquisition unit 101 and the user status provided by the user status acquisition unit 102 to make an assessment as to the need for operation control over the appliances being used by the user 109.

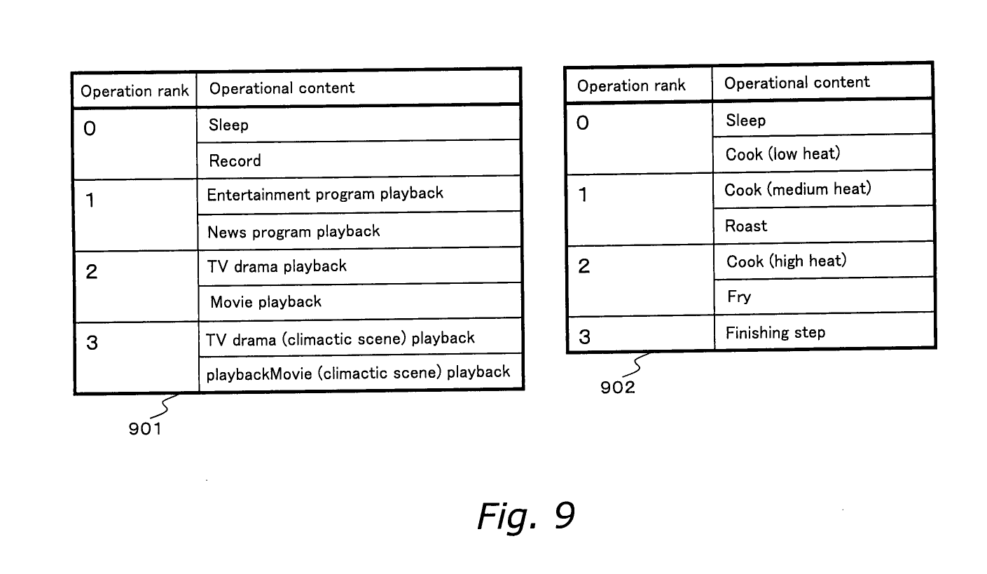

First of all, the appliance status management unit 103 uses the information acquired by the appliance status acquisition unit 101 to make an assessment of the amount of resources required by the appliances. FIG. 9 is an operation rank table used for computing the operation rank required by the appliances depending on the operation. In FIG. 9, the key 901 designates an operation rank table for a TV, and the key 902 an operation rank table for an IH cooker. When the appliances carry out their activities, the extent, to which user contribution is required, is computed based on such a table. For instance, a TV performing “news program playback” requires an operation rank of 1, and an IH cooker performing “finishing steps” requires an operation rank of 3. It should be noted that although the appliance status management unit 103 has tables similar to the operation rank tables of FIG. 9 for each resource type, in the following, tables or computational expressions used to compute the electric power, communication bands, etc. required by the appliances are omitted because this embodiment deals only with operation ranks.

After computing resources required for the operation of all the appliances currently used by the user 109, the appliance status management unit 103 performs a comparison of their total and the total of the possible resources currently allocatable by the user 109, acquired from the user status acquisition unit 102 in Step 202. If the results of the comparison show that the sum total of the operation ranks required by the appliances being used by the user 109 exceeds the total of the operation ranks that the user 109 can allocate (sum total of requested operation ranks>operating ranks the user can allocate), it is determined that the concentration and attention of the user 109 will become insufficient if the activities of all the appliances are continued without modification, and operation rank allocation modification processing is carried out for each of the appliances.

(Step 204)

The activity concern level assessment unit 104 uses the user status acquired by the user status acquisition unit 102 in order to assess the level of concern on the part of the user 109 with respect to the appliances currently used by the user 109. The activity concern level assessment unit 104 uses a “concern level” value to handle the level of the concern on the part of the user 109 with respect to the appliances. A higher value of the level of concern with respect to a particular appliance operation indicates that the level of concern on the part of the user 109 with respect to the operation of the appliance is higher.

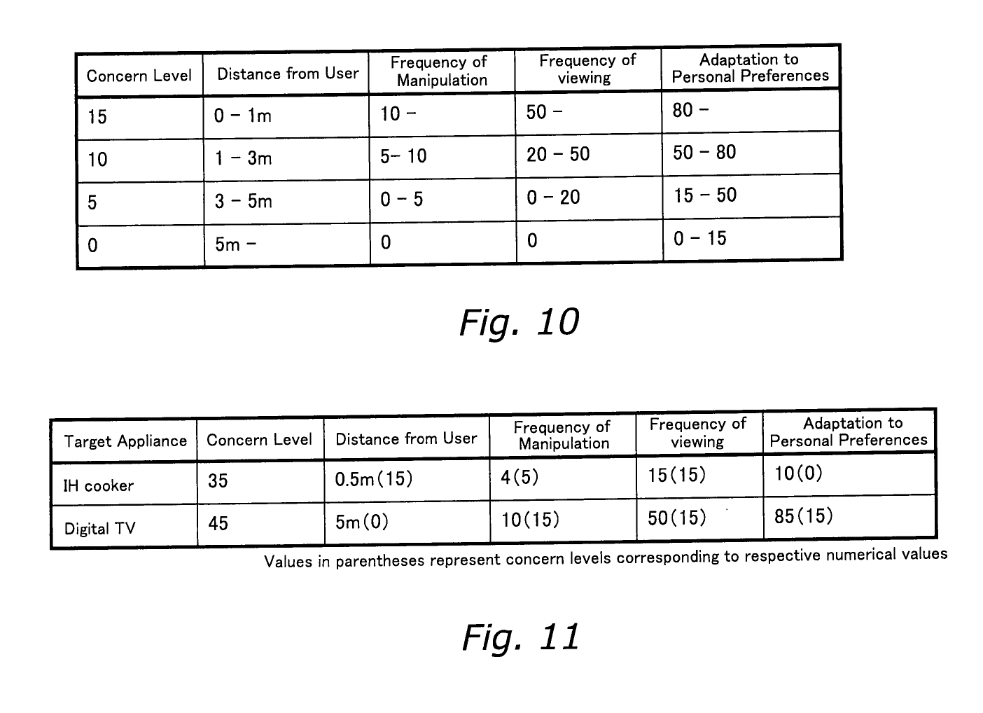

The activity concern level assessment unit 104 maintains a concern level computation table used for computing the level of concern with the appliances based on the user status. The concern level computation table is illustrated in FIG. 10. The concern level computation table represents correspondence between the user status acquired by the user status acquisition unit 102 and the status of the user with respect to the appliances illustrated in FIG. 6. In other words, the concern level computation table is a conversion table used for converting individual values such as the distance between the user 109 and the appliances, the frequency of manipulation, the frequency of viewing, and the level of adaptation to appliance-related personal preferences into a “concern level”. FIG. 11 represents the results of computation of the concern level with respect to FIG. 6 using the concern level computation table of FIG. 10. According to FIG. 11, it is found that the concern level of the user 109 with respect to the IH cooker is 35 and the level of concern with the digital TV is 45. As a result, it is found that the user 109 has a higher level of concern with the activity performed by the digital TV (digital TV viewing and recording operations, etc.) than that of the IH cooker. The activity concern level assessment unit 104 transmits the computed concern level to the appliance operation arbitration unit 106.

(Step 205)

The activity importance level assessment unit 105 assesses the importance level attached to the appliance operational content acquired by the appliance status acquisition unit 101. The higher the importance level of an activity, the less permissible are errors in terms of safety and cost, and, therefore, it is determined that allocating more resources thereto is better. Methods used in the assessment of the importance level of activities are illustrated below.

1. Importance Assessment Table

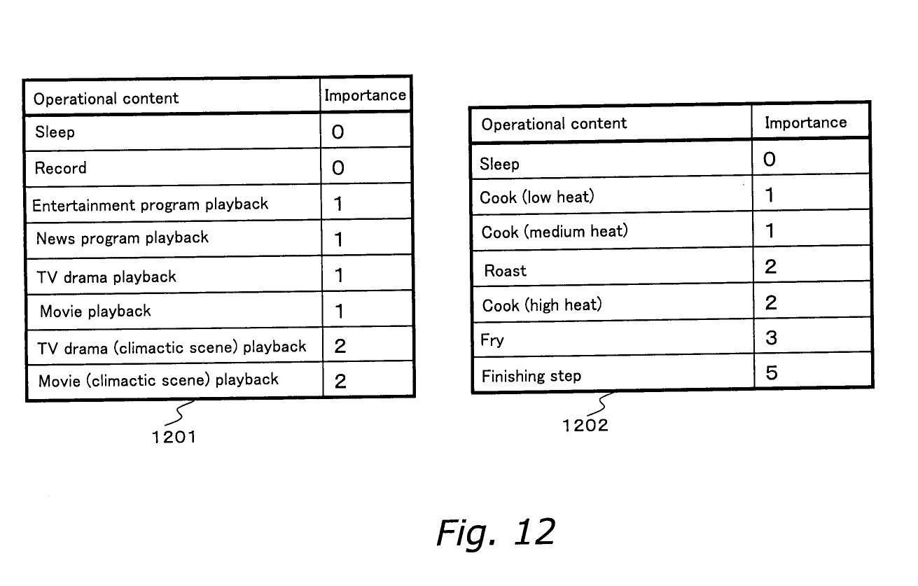

FIG. 12 shows tables used for the assessment of importance level of the operational content of the appliances. Namely, these tables show activities taking place in the appliances and the level of importance corresponding to the activities. In FIG. 12, the key 1201 designates a TV importance level assessment table and the key 1202 an IH cooker importance level assessment table. The importance level assessment tables are maintained by the activity importance level assessment unit 105. The activity importance level assessment unit 105 assesses the importance level of the appliances based on the current operational content of the appliances, and has the tables stored therein in advance.

2. Use of Metadata

When the appliance status acquisition unit 101 acquires metadata illustrated in FIG. 4 from the appliances, the activity importance level assessment unit 105 assesses the importance level of their activities using the values of importance and difficulty level contained in the metadata. Because the metadata 401 of FIG. 4 contains an importance value, the level of importance of the appliances is assessed based on this value. In addition, the metadata 402 of FIG. 4 also contains a difficulty value. The activity importance level assessment unit 105 uses the ontology illustrated in FIG. 5 to make an assessment that the level of difficulty and the level of importance are semantically similar and assesses the importance level of the IH cooker based on the level of difficulty. It should be noted that the activity importance level assessment unit 105 may utilize a method, in which the level of importance of the appliances is computed by using not only the operating status obtained from the appliance status acquisition unit 101, but also the user status from the user status acquisition unit 102 and by maintaining a complex knowledge base that stores computational expressions, whereby the level of importance is modified depending on the status of the user.

(Step 206)

The activity importance level assessment unit 105 transmits the computed level of importance to the appliance operation arbitration unit 106.

When the appliance status management unit 103 makes an assessment that there is a need to exercise control over the appliances 108a, 108b used by the user 109, the appliance operation arbitration unit 106 determines the resources allocated by the appliances. Namely, the appliance operation arbitration unit 106 determines the allocation of resources to the appliances based on the level of concern computed by the activity concern level assessment unit 104 and the level of importance computed by the activity importance level assessment unit 105.

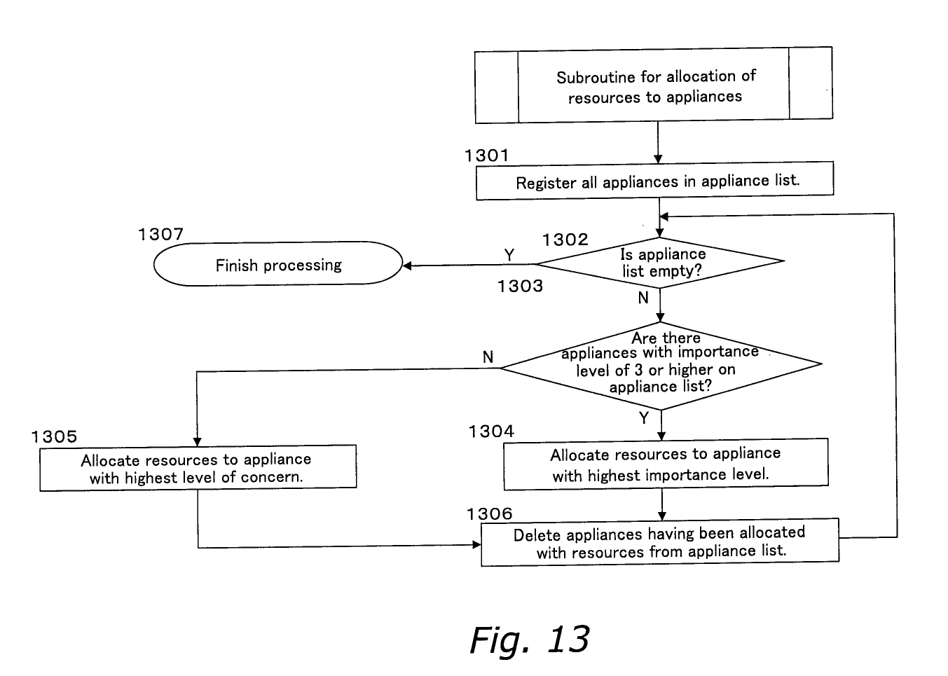

FIG. 13 illustrates the processing flow of resource allocation to appliances in the present embodiment.

(Step 1301)

The appliance operation arbitration unit 106 adds appliances requiring resource allocation to the appliance list. If a user is preparing a meal in the IH cooker while watching TV, the TV and the IH cooker are added to the appliance list.

(Step 1302)

The appliance operation arbitration unit 106 makes an assessment as to whether or not the appliance list is empty. When the appliance list becomes empty upon completion of resource allocation to all the appliances, the operating status arbitration unit 106 terminates processing.

(Step 1303)

The appliance operation arbitration unit 106 uses the computation results of the activity importance level assessment unit 105 to make an assessment as to whether or not the appliance list contains appliances with an importance level of 3 or higher.

(Step 1304)

If there are appliances with an importance level of 3 or higher, the appliance operation arbitration unit 106 allocates resources to appliances of high importance level. In other words, the appliance operation arbitration unit 106 allocates resources required by the appliances to appliances having the highest importance level among the appliances with an importance level of 3 or higher. If the amount of resources that can be provided by the user 109 at the present moment is smaller than the amount of resources requested by the appliances (amount of resources providable by user 109<amount of resources requested by the appliances), then all the resources are provided that can be provided by the user 109 at the present moment.

(Step 1305)

If there are no appliances with an importance level of 3 or higher, the appliance operation arbitration unit 106 allocates resources to appliances with a high level of concern. In other words, the appliance operation arbitration unit 106 uses the computation results of the activity concern level assessment unit 104 to select appliances with the highest level of concern on the appliance list and allocates the resources required by the appliances to the selected appliances. If the amount of resources that can be provided by the user 109 at the present moment is smaller than the amount of resources requested by the appliances (amount of resources providable by user 109<amount of resources requested by the appliances), then all the resources are provided that can be provided by the user 109 at the present moment.

(Step 1306)

The appliance operation arbitration unit 106 removes the appliances that have been allocated resources in Step 1304 or Step 1305 from the appliance list and processes Step 1302.

Based on the above-described processing flow from Step 1301 to Step 1306, the appliance operation arbitration unit 106 can prevent activities of high importance level from being interrupted and failing by preferentially allocating resources to activities of high importance level when allocating resources to the appliances. Moreover, by giving preference to the level of concern in case of low-importance level activities during allocation of resources to the appliances, the appliance operation arbitration unit 106 can prevent activities of interest to the user 109 from being interrupted by activities of no particular interest.

For instance, in the example of FIG. 11, the level of concern with the digital TV turns out to be higher if the level of concern with the IH cooker and the level of concern with the TV are compared. In other words, the user 109 has a stronger concern with the digital TV than with the IH cooker. If the operation ranks requested by the digital TV and the IH cooker exceed the operation ranks the user can provide (operation ranks the user can provide<operation ranks requested by the appliances), the appliance operation arbitration unit 106 preferentially allocates the operation rank etc. to the digital TV so as not to disturb the viewing of digital TV by the user 109. However, if the operational content item of the IH cooker, which has a low level of concern, is an activity of high importance level, such as a “finishing step” etc., the appliance operation arbitration unit 106 preferentially allocates resources to the IH cooker in order to avoid the risk of this activity failing. Upon completion of resource allocation to the appliances being used by the user 109, the appliance operation arbitration unit 106 notifies the appliance operation control unit 107 of the amount of resources allocated to each appliance. Although, as described above, the resources allocated to the appliances are determined basically in accordance with the user's level of concern, when the importance level of the appliances exceeds a certain threshold value, the resources allocated to the appliances are determined by giving preference to the importance level of the appliances rather than the user's level of concern. (Step 207)

The appliance operation control unit 107 determines the control carried out by each appliance in practice depending on the resources allocated by the appliance operation arbitration unit 106.

(Step 208)

Next, to notify the user, the appliance operation control unit 107 outputs the appliances subject to control and the contents of control to the displays, speakers, etc. of the appliances used by the user. As a result of the notification, the user can confirm which appliances should be controlled and in what way. If the user has not authorized appliance control, the processing returns to Step 201 without execution.

(Steps 209, 210)

Upon receipt of authorization from the user to control the appliances subject to control based on the determined operational content, the processing proceeds to Step 210, and the appliance operation control unit 107, whose role is described below, controls the appliances subject to control based on the determined operational content.

1. Selects Specific Operations

The appliance operation control unit 107 assesses the operational content that the appliances can execute using the resources that have been allocated based on the operation rank table illustrated in FIG. 9. For instance, it shows that the TV, which has been allocated the operation rank of 0, can execute operations such as “sleep” and “record”. Therefore, the appliance operation control unit 107 notifies the TV through the network to process either one of “sleep” or “record”.

2. Informs of Appliances Subject to Control and Contents of Control

Before exercising control over the appliances subject to control, the appliance operation control unit 107 outputs the appliances to be controlled and the determined contents of control to the displays, speakers, etc. of the appliances used by the user to notify the user thereof. Then, upon receipt of authorization for control, the appliance operation control unit 107 carries out control based on the determined control content.

3. Informs Only of the Allocated Resources.

If the information used to assess the activities that can be carried out by the appliances, i.e. the TV and the IH cooker, using the allocated resources is maintained in the form illustrated in the operation rank table of FIG. 9, the appliance operation control unit 107 notifies the appliances only of the amount of allocated resources. The appliances receiving the information on the amount of allocated resources make their own assessment of the processing that can be carried out based on the resources and carry out the activities. The order of execution of Step 201 and Step 202 may be altered or they may be carried out simultaneously. The order of execution of Step 204 and Step 205 may be altered or they may be carried out simultaneously.

Although the targeted user in the present embodiment of the invention was one person, the appliance operation control device 100 can control the operation of the appliances based on the status of a plurality of users.

(Effects)

By using the appliance operation control device of the present invention, operation control over a plurality of appliances can be carried out not only with account taken of the status of the appliances, but also based on the status of the user, with account taken of the user's level of concern with the activities of the appliances and the importance level of the activities of the appliances. For this reason, for instance, when a user who is watching TV while preparing a meal in an IH cooker is more concerned with watching TV than cooking, the invention makes it possible to avoid situations, in which displeasure to the user would be caused by powering off the TV, which is of greater concern to the user. Moreover, when the activity taking place in the IH cooker is an activity involving a cooking step of high importance level, processing such as powering off the TV is performed in order to give priority to processing of high importance level even though the user may be strongly concerned with watching TV.

In the embodiments described above, after user notification and confirmation in Steps 208 and 209, control over the appliances is established in Step 210. However, user notification and confirmation are not essential, and Steps 208 and 209 are not essential either. In addition, user confirmation is not essential, and, after notifying the user, control over the appliances may be established automatically upon lapse of a certain time period.

In addition, in the embodiments described above, the digital TV and IH cooking period is controlled based on the operation ranks of the appliances, the user's level of concern, importance, and the like. However, the appliances subject to control are not limited to the appliances above. For instance, if a phone call, an e-mail, or another interruption happens while a user is watching TV, the TV, phone, and e-mail are controlled based on the respective operation ranks, level of concern, importance, etc. of watching TV and responding to the phone call or emails. In addition, in case of e-mail, the importance level of the content of the e-mail may be determined based on the source address of the e-mail. For instance, in case of spam email, control is exercised by reducing its importance level and deleting it, etc. such that the user does not have to respond to the e-mail. In addition, comparison is not limited to comparison between the operation ranks, user concern levels and importance levels of two types of appliances and simultaneous control may be effected by comparing three or more types of appliances.

### OTHER EMBODIMENTS

(1)

In addition, the scope of the present invention also includes a computer-readable recording medium, which has recorded thereon a computer program directing a computer to execute the method described above, as well as a program therefor. Here, flexible disks, hard disks, CD-ROMs, MOs, DVDs, DVD-ROMs, DVD-RAMs, BDs (Blue-ray Disks), and semiconductor memory can be cited as examples of the computer readable recording media.

The computer program mentioned above is not limited only to programs recorded on the recording media described above and may be transmitted through networks etc. represented by telecommunication lines, wireless or wired communication lines, and the Internet.

(2)

The network connections described above may be wired or wireless. In addition, not only conventional coaxial cables, twisted-pair cables, and other LAN cables, but also telephone lines, fiber optic cables, and power lines (electric lamp lines, three-phase AC power lines, DC lines, etc.) may be used in case of wired networks.

(3)

The functionality of the appliance operation control device described in the embodiments may be implemented as an LSI integrated circuit. While the name used here is LSI, depending on the level of integration, it may be an IC, a system LSI, a super LSI, or an ultra LSI.

In addition, the method of implementing the functionality in the form of integrated circuits is not limited to LSI, and may include dedicated circuits or general-purpose processors. Upon fabrication of the LSI, it is possible to use programmable FPGA (Field Programmable Gate Arrays) and reconfigurable processors, which permit reconfiguration of settings and connections between LSI circuit cells.

### INDUSTRIAL APPLICABILITY

The appliance operation control device of the present invention can be applied to devices that provide appropriate automatic control over the operation of appliances with account taken of the user's attention etc. in case of performing a plurality of activities at home etc.

1. An appliance operation control device comprising:
an appliance status acquisition unit acquiring the respective operating status of appliances used by a user;
a user status acquisition unit acquiring a user status associated with the user;
an activity concern level assessment unit assessing the user's level of concern with the activities performed by the appliances based on the user status or the user status and the operating status of the appliances;
an activity importance level assessment unit assessing the importance level of the activities of the appliances based on the operating status of the appliances or the operating status of the appliances and the user status;
an appliance status management unit making an assessment as to whether or not there is a need for operation control over the appliances used by the user based on the operating status of the appliances and the user status;
an appliance operation arbitration unit determining a method of operation control over the appliances based on the level of concern and the level of importance if the appliance status management unit makes an assessment that there is a need for operation control; and
an appliance operation control unit carrying out the operation control over the appliances based on the operation control method determined by the appliance operation arbitration unit.

2. The appliance operation control device according to claim 1, wherein:
the user status acquired by the user status acquisition unit contains information on the current amount of user-providable resources, and
the appliance status management unit assesses the amount of resources required by the appliances to perform activities depending on the operating status of the appliances acquired by the appliance status acquisition unit and makes an assessment as to whether or not there is a need for operation control by comparing the total value of the resources required by the appliances and the current amount of the user-providable resources.

3. The appliance operation control device according to claim 1, wherein the activity concern level assessment unit assesses the user's level of concern with the activities of the appliances using at least one parameter from among a distance between the user and the appliances, the frequency of viewing with which the user views the appliances, the frequency of manipulation with which the user manipulates the appliances, and the user's personal preferences with respect to the activities of the appliances that are acquired by the user status acquisition unit.

4. The appliance operation control device according to claim 2, wherein the operation control carried out by the appliance operation arbitration unit includes allocation of current user-providable resources acquired by the user status acquisition unit to the appliances based on the value of importance level and concern level.

5. The appliance operation control device according to claim 2, wherein the resources are the level of the user's contribution to the activities of the appliances.

6. The appliance operation control device according to claim 4, wherein the resources are the level of the user's contribution to the activities of the appliances.

7. An appliance operation control method, which is an appliance operation control method executable by a computer and is comprising:
appliance status acquisition step of acquiring the respective operating status of appliances used by a user;
user status acquisition step of acquiring a user status associated with the user;
activity concern level assessment step of assessing the user's level of concern with activities performed by the appliances based on the user status or the user status and the operating status of the appliances;
activity importance level assessment step of assessing the importance level of the activities of the appliances based on the operating status of the appliances or the operating status of the appliances and the user status;
appliance status management step of making an assessment as to whether or not there is a need for operation control over the appliances used by the user based on the operating status of the appliances and the user status;
appliance operation arbitration step of determining a method of operation control over the appliances based on the level of concern and the level of importance when an assessment is made in the appliance status management step that there is a need for operation control; and
appliance operation control step of carrying out the operation control over the appliances based on the operation control method determined in the appliance operation arbitration step.

8. An appliance operation control program, which directs a computer to function as:
appliance status acquisition unit for acquiring the respective operating status of appliances used by a user;
user status acquisition unit for acquiring a user status associated with the user;
activity concern level assessment unit for assessing the user's level of concern with activities performed by the appliances based on the user status or the user status and the operating status of the appliances;
activity importance level assessment unit for assessing the importance level of the activities of the appliances based on the operating status of the appliances or the operating status of the appliances and the user status;
appliance status management unit for making an assessment as to whether or not there is a need for operation control over the appliances used by the user based on the operating status of the appliances and the user status;
appliance operation arbitration unit for determining the method of operation control over the appliances based on the level of concern and the level of importance when the appliance status management unit makes an assessment that there is a need for operation control; and
appliance operation control unit for carrying out the operation control over the appliances based on the operation control method determined by the appliance operation arbitration unit.

9. A computer-readable recording medium having recorded thereon an appliance operation control program executable by a computer,
the appliance operation control program executing:
appliance status acquisition step of acquiring the respective operating status of appliances used by a user;
user status acquisition step of acquiring a user status associated with the user;
activity concern level assessment step of assessing the user's level of concern with the activities performed by the appliances based on the user status or the user status and the operating status of the appliances;
activity importance level assessment step of assessing the importance level of the activities of the appliances based on the operating status of the appliances or the operating status of the appliances and the user status;
appliance status management step of making an assessment as to whether or not there is a need for operation control over the appliances used by the user based on the operating status of the appliances and the user status;
appliance operation arbitration step of determining a method of operation control over the appliances based on the level of concern and the level of importance when an assessment is made in the appliance status management step that there is a need for operation control; and
appliance operation control step of carrying out the operation control over the appliances based on the operation control method determined in the appliance operation arbitration step.
